(19) United States
(12) Patent Application Publication
(10) Pub. No.: US 2019/0030842 A1
(43) Pub. Date: Jan. 31, 2019

(54) HEATED COLLAPSIBLE ELASTOMERIC BLADDER TOOL TO FORM AND REPAIR COMPOSITE STRUCTURES

(71) Applicant: Rubbercraft Corporation of California, Ltd., Long Beach, CA (US)

(72) Inventors: Isaac Miranda, Long Beach, CA (US); Robert Harshberger, Lakewood, CA (US); Mathias Hecht, Flagstaff, AZ (US)

(73) Assignee: Rubbercraft Corporation of California, Ltd., Long Beach, CA (US)

(21) Appl. No.: 16/046,924

(22) Filed: Jul. 26, 2018

Related U.S. Application Data
(60) Provisional application No. 62/537,886, filed on Jul. 27, 2017.

(51) Int. Cl. B29C 73/12; B29C 70/44

(52) U.S. Cl. CPC B29C 73/12; B29K 2823/16; B29C 70/44

(57) ABSTRACT

Disclosed is a collapsible heated elastomeric bladder tool for repairing damage to composite structures. The elastomeric bladder tool can be used to repair composite structures in difficult to reach areas, such as under stringers used to stiffen large structures. The elastomeric bladder tool can be inserted into the damaged cavity such as a stringer to support uncured plies during the repair on either surface of the cavity. Integrated heating elements within the elastomeric bladder tool provide heat to cure the plies. The elastomeric bladder tool features a collapsed cross section that facilitates installation and extraction.

### CROSS-REFERENCE TO RELATED APPLICATION

The present application claims priority to U.S. Provisional Application No. 62/537,886, filed on Jul. 27, 2017, the entire contents of which are incorporated by reference as if fully set forth herein.

### TECHNICAL FIELD

The present disclosure relates generally to the field of composite structures and, more particularly, to systems, apparatus, and methods for forming and repairing composite structures.

### BACKGROUND

Composite fuselage and nacelle structures may be subjected to impact damage in various ways: birds, airport service vehicles, equipment, maintenance, lighting strikes, etc. An effective and efficient repair is imperative in order to restore the structural integrity to the composite structure while minimizing aircraft downtime. Conventional approaches to composite structure repairs include two primary types of repair methods: bolted repairs and bonded repairs. While bolted repairs can be performed quickly, bolted repairs require the addition of bolt holes, which damage and weaken the composite structure. Bolted repairs are also aesthetically non-optimal, as they generally result in a visible patch. A bonded repair may be preferable for its aesthetically pleasing and near seamless integration into the composite structure. However, conventional approaches to bonded repairs are often more complex and difficult than performing bolted repairs. As such, despite the drawbacks discussed above, bolted repairs are often the default repair method due to their relatively simplicity and quick turnaround time.

### SUMMARY OF THE INVENTION

The present disclosure may be embodied in an elastomeric bladder tool that comprises an elastomeric outer wall, an inner cavity at least partially defined by the elastomeric outer wall, and an embedded heating system embedded within the elastomeric outer wall.

In an embodiment, the embedded heating system comprises resistance wire embedded within the elastomeric outer wall.

In an embodiment, the embedded heating system distributes heat throughout the elastomeric outer wall and maintains flexibility of the elastomeric outer wall.

In an embodiment, the embedded heating system further comprises woven glass surrounding the resistance wire.

In an embodiment, the elastomeric bladder tool further comprises one or more raised edge seals positioned along and protruding from the elastomeric outer wall.

In an embodiment, the one or more raised edge seals comprise elastomer material of equal or lower durometer than the elastomeric outer wall.

In an embodiment, the elastomeric outer wall comprises at least one of: fluoroelastomer, silicone, butyl-rubber, or ethylene propylene diene monomer rubber (EPDM).

In an embodiment, the elastomeric outer wall comprises an outermost layer, and the outermost layer comprises an inert polymer to reduce friction during insertion or extraction of the elastomeric bladder tool from a composite structure.

In an embodiment, the elastomeric outer wall is in a collapsed state in normal atmospheric conditions, and the elastomeric outer wall can be expanded into an expanded state by applying positive pressure to the inner cavity.

In an embodiment, the elastomeric bladder tool further comprises an end fitting configured to allow gas or fluid to be inserted into and extracted from the internal cavity.

The present disclosure may also be embodied in a method in which an elastomeric bladder tool is positioned in a collapsed state proximate a repair area of a composite structure. The elastomeric bladder tool comprises an embedded heating system. The elastomeric bladder tool is expanded to an expanded state. In the expanded state, the elastomeric bladder tool provides support for one or more plies placed on the repair area of the composite structure. Heat is applied to the one or more plies using the embedded heating system.

In an embodiment, the elastomeric bladder tool is collapsed to the collapsed state, and the elastomeric bladder tool is extracted from the composite structure in the collapsed state.

In an embodiment, the elastomeric bladder tool comprises one or more raised edge seals positioned along and protruding from an outer surface of the elastomeric bladder tool.

In an embodiment, expanding the elastomeric bladder tool to the expanded state causes the one or more raised edge seals to create an air-tight seal around the repair area.

The present disclosure may also be embodied in a composite structure repair system comprising: a composite structure comprising a repair area to be repaired; one or more plies positioned on the repair area; an elastomeric bladder tool positioned proximate the one or more plies, the elastomeric bladder tool comprising an elastomeric outer wall, an inner cavity at least partially defined by the elastomeric outer wall, and an embedded heating system embedded within the elastomeric outer wall; a pressure regulator in communication with the inner cavity for alternating the elastomeric bladder tool between a collapsed state and an expanded state; and a temperature controller connected to the embedded heating system for controlling a temperature of the embedded heating system.

In an embodiment, in the expanded state, the elastomeric bladder tool provides support for the one or more plies.

In an embodiment, in the expanded state, the elastomeric bladder tool is configured to apply heat to an interior surface of the one or more plies using the embedded heating system.

In an embodiment, the elastomeric bladder tool further comprises one or more raised edge seals positioned along and protruding from the elastomeric outer wall.

In an embodiment, the one or more raised edge seals comprise elastomer material of equal or lower durometer than the elastomeric outer wall.

Although various combinations of limitations have been disclosed respecting each of the systems and methods described above, it should be appreciated that these do not constitute every limitation disclosed herein, nor do they constitute every possible combination of limitations. As such, it should be appreciated that additional limitations and different combinations of limitations presented within this disclosure remain within the scope of the disclosed invention.

These and other features and advantages of the invention should become more readily apparent from the detailed description of the preferred embodiments set forth below taken in conjunction with the accompanying drawings, which illustrate, by way of example, the principles of the invention.

### BRIEF DESCRIPTION OF THE DRAWINGS

FIG. 1 provides a close-up perspective view of a section of an elastomeric bladder tool, in accordance with an embodiment of the present disclosure.

FIG. 2 provides a cross-sectional view of an elastomeric bladder tool, in accordance with an embodiment of the present disclosure.

FIG. 3 provides a cross-sectional view of an elastomeric bladder tool, in accordance with an embodiment of the present disclosure.

FIG. 4 provides a perspective view of a composite structure repair system, in accordance with an embodiment of the present disclosure.

FIG. 5 provides a perspective view of a composite structure repair system, in accordance with an embodiment of the present disclosure.

FIG. 6 provides a flow chart of an example method associated with composite structure repair, in accordance with an embodiment of the present disclosure.

The drawings are provided for purposes of illustration only and merely depict typical or example implementations. One skilled in the art will readily recognize from the following discussion that alternative embodiments of the structures and methods illustrated in the figures can be employed without departing from the principles of the disclosed technology described herein. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION OF VARIOUS EMBODIMENTS

Composite fuselage and nacelle structures may be subjected to impact damage in various ways: birds, airport service vehicles, equipment, maintenance, lighting strikes, etc. An effective and efficient repair is imperative in order to restore the structural integrity to the composite structure while minimizing aircraft downtime. Conventional approaches to composite structure repairs include two primary types of repair methods: bolted repairs and bonded repairs.

In general, a bolted repair can provide a quick turnaround and substantially minimize aircraft downtime. Typically, in bolted repairs, a damaged area of a composite structure is assessed to determine the extent of the needed repair. A patch panel can be fabricated to bolt over the damaged area. Typically, patch panels are constructed from titanium or aluminum sheets. The repair area is prepared before the patch panel is installed. Cracks are typically drilled to prevent further crack propagation and panel bolt patterns are predrilled.

One advantage of a bolted repair, compared to conventional bonded repairs, is that the aircraft can be repaired easily in the field. One disadvantage of a bolted repair is that the damaged area on a composite structure is made larger and the composite structure is further weakened by drilling outside the damaged area. Furthermore, the additional bolt holes weaken the composite structure by introducing point stress concentrations. Another drawback to bolted repairs includes the fact that bolts and the patch panel affect the aerodynamic properties of the composite structure. This may be particularly important, for example, if the composite structure makes up a portion of an aircraft or other vehicle. In sum, bolted repairs are convenient because they can be performed quickly, but there are significant disadvantages in terms of structural integrity and aerodynamic performance.

A bonded repair is typically the most effective approach to repair a composite structure. Bonded repairs avoid additional damage to the composite structure and provide a superior surface finish. Rather than using a patch panel made of titanium or aluminum, a bonded repair can use a composite material that is similar or identical to the material in the composite structure. This ensures a better coefficient of thermal expansion and mechanical property matching to the repair area for more optimal long-term performance. Another advantage of the bonded repair is that the repair zone is kept minimal, since there is no need for fasteners. With bonded repairs, the aerodynamic properties of the composite structure are generally not materially compromised, since the repair area remains relatively flush with the original surface. Additionally, the finish of a bonded repair is more aesthetically appealing when compared to bolted repairs.

In bonded repairs, the edges of a repair area (e.g., a damaged area) of a composite structure can be sanded at a predetermined angle to increase the bonding area and allow better load transfer. Then, new uncured plies can be placed over the repair area and cured using known composite fabrication procedures. Conventional approaches to bonded repairs may utilize flat heating blankets and a vacuum bag system. A common issue with using flat heating blankets is that the edges of the flat heating blankets often do not reach adequate temperature and the blanket does not conform, for example, to stringers used to stiffen large composite structures (such as aircraft structures) near surface features such as radii or inside the stringers. Porosity and insufficient consolidation can occur at the radii. Another problem often arising with conventional approaches to bonded repairs is that the inner vacuum bag of the vacuum bag system can tear during extraction and Foreign Object Debris (FOD) can be trapped within the repair. This FOD must then be removed, which adds to repair time and cost.

Yet another disadvantage of conventional approaches to bonded repair is the complexity of the process, which often requires specially trained personnel and special equipment. Furthermore, preparing the repair area for repair can be meticulous and time consuming. As a result, bonded repairs can be significantly slower and more difficult than bolted repairs. Additionally, the surrounding composite structure around a repair area may have a limit for how long it can be heated without impacting its mechanical properties.

The presently disclosed technologies improve, simplify, and aid the bonded repair process. Various embodiments of the disclosed technologies can reduce the complexity of bonded repairs by generating a more uniform temperature and pressure distribution across a composite structure repair area, and can reduce porosity. Furthermore, various embodiments of the present disclosure allow for easier installation and extraction of elastomeric bladder tooling used in bonded repair, and can eliminate the problematic internal bag component from a bonded repair vacuum bag system. Various embodiments of the present disclosure can also enable repair of composite structures around trapped cavities. By removing these issues that commonly arise in conventional approaches to bonded repair of composite structures, the quality of the bonded repair can be improved and the process can be made more efficient and effective. Various aspects of the disclosed technologies are described in greater detail herein.

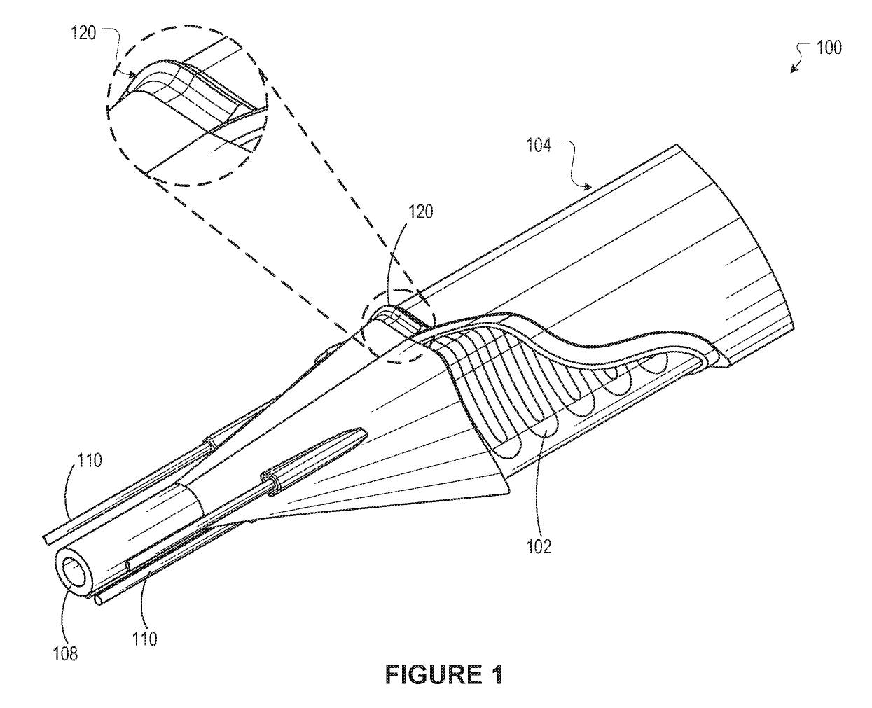

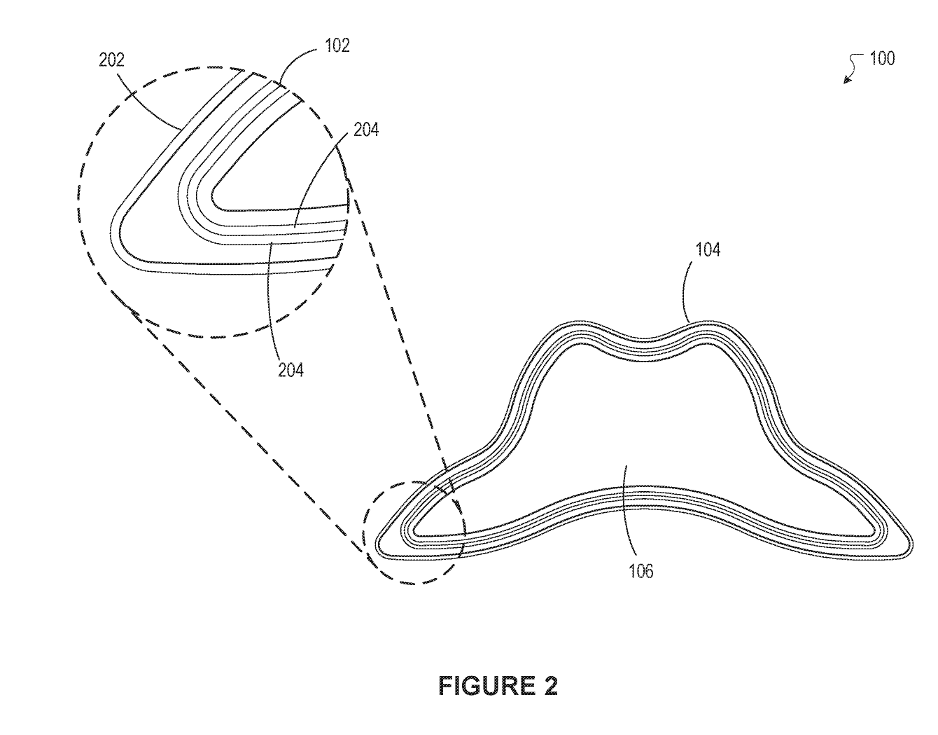

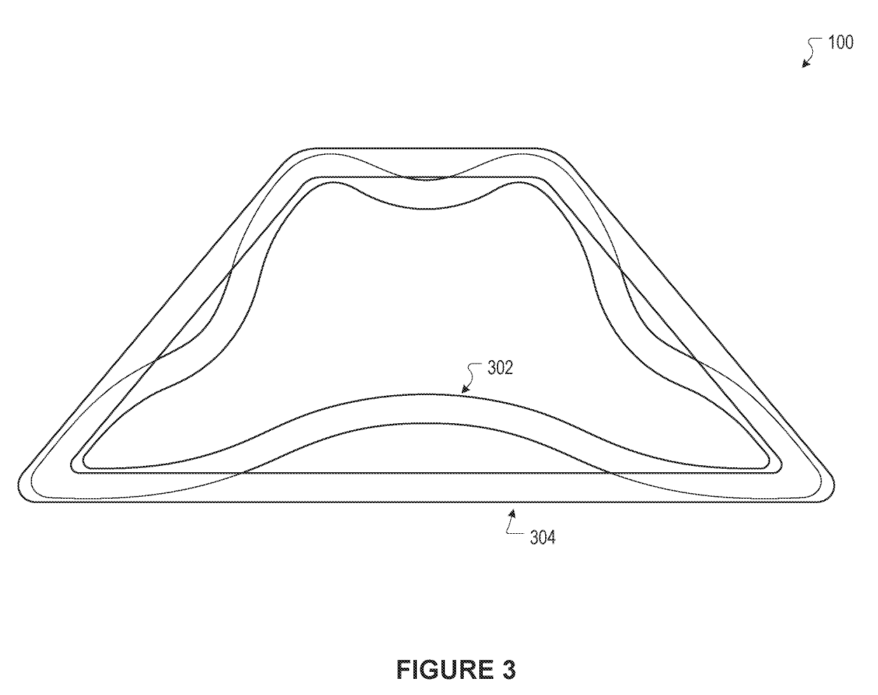

FIG. 1 illustrates a section of an elastomeric bladder tool 100 according to an embodiment of the present disclosure. In FIG. 1, the section of the elastomeric bladder tool 100 is depicted with a partial cutout to show embedded heating elements 102. The embedded heating elements 102 may be implemented, for example, using resistance wire, which can be externally connected to a temperature controller and/or a power source through one or more leads 110. As will be described in greater detail below, an edge seal 120 can be included to seal a composite area (e.g., a repair area) against the outside for application of an external vacuum. FIG. 2 illustrates a cross-sectional view of the elastomeric bladder tool 100, according to an embodiment of the present disclosure. In an embodiment, the elastomeric bladder tool 100 can comprise an outer wall 104 formed of a flexible, elastomeric material, and an internal cavity 106 at least partially defined by the outer wall 104. Under normal atmospheric conditions, the natural state of the elastomeric bladder tool 100 can be a flexible, collapsed state. FIG. 2 shows the elastomeric bladder tool 100 in its natural collapsed state. When positive pressure is applied to the interior surface of the outer wall 104 of the elastomeric bladder tool 100, the elastomeric bladder tool 100 can expand into an active state or expanded state in which the elastomeric bladder tool 100 assumes a relatively more rigid, predetermined shape. FIG. 3 illustrates a cross-sectional view of the elastomeric bladder tool 100 according to an embodiment of the present disclosure. FIG. 3 depicts the elastomeric bladder tool 100 both in its natural, collapsed state (302) and in its expanded, active state (304).

In an embodiment, the elastomeric bladder tool 100 is open on at least one end to allow for one or more gas or fluid connections. A collapsed elastomeric bladder tool 100 can be deployed into its active (or expanded) state by applying positive pressure to the interior of the elastomeric bladder tool 100 through an end fitting 108, as shown most clearly in FIG. 1. For example, the end fitting 108 may be connected to a pressure regulator which applies internal pressure to the elastomeric bladder tool 100 by pumping gas or fluid into the internal cavity 106 of the elastomeric bladder tool 100. In its natural, collapsed state, the slightly collapsed, somewhat flexible form of the elastomeric bladder tool 100 allows for reduced frictional forces during installation and extraction of the elastomeric bladder tool 100. If needed, vacuum can be applied to the internal cavity 106 to further collapse the cross-section of the elastomeric bladder tool 100 during installation and extraction. Although the elastomeric bladder tool 100 in its natural state is collapsed and at least somewhat flexible, the elastomeric bladder tool 100 may, even in its natural state, have sufficient structural rigidity along the length of the elastomeric bladder tool 100 to allow for the elastomeric bladder tool 100 to be easily inserted into long, narrow composite structures, such as stringers.

A common problem with conventional vented bladders is that uncured plies placed over a repair area of a composite structure may remain unstable. In some cases, vacuum pressure applied by a conventional vacuum bag system is not enough to support the uncured plies. With the presently disclosed technologies, the elastomeric bladder tool 100 can be collapsed to have a smaller cross-sectional area during insertion into a repair area and extraction from a repair area, and once the elastomeric bladder tool 100 is inserted into a composite structure, it can be expanded into its active state. By providing positive pressure to the elastomeric bladder tool 100 from inside the cavity, the elastomeric bladder tool 100, in its active, expanded state, can stabilize uncured plies during the curing process. Furthermore, heating elements 102 embedded into the elastomeric bladder tool 100 can be used to apply direct heat to a repair area from inside a composite structure, which was not possible with conventional heated blankets, which could only be laid over a repair area from outside the composite structure.

In the embodiment depicted in FIG. 1, heating elements 102 are integrated within the outer wall 104 of the elastomeric bladder tool 100 across the entire length of the elastomeric bladder tool 100 and along both a top surface and a bottom surface of the elastomeric bladder tool 100. In the depicted embodiment, the heating elements 102 are arranged in a pattern such that heat is substantially evenly distributed throughout the elastomeric bladder tool 100 while maintaining flexibility of the elastomeric bladder tool 100. Leads 110, protruding from an end of the elastomeric bladder tool 100, are connected to the internal heating elements 102. The leads 110 can be connected to a power source (e.g., a temperature controller) to heat up the heating elements 102 and control their temperature. In some embodiments, the elastomeric bladder tool 100 may contain one or more zones, depending on the length of a repair area on a composite structure. Each zone may have one or more leads 110 for powering heating elements 102 within the zone.

The elastomeric bladder tool 100 can also include one or more raised edge seals 120 on an outer surface of the outer wall 104. In various embodiments, as will be described in greater detail below, the edge seals 120 can be used to eliminate the need for an interior vacuum bag. When the elastomeric bladder tool 100 is inserted into a repair area, and then is inflated to fill and support the repair area, the raised edge seals 120 can tightly seal off the repair area. In this way, the edge seals 120 can eliminate the need for an interior vacuum bag on an interior surface of the repair area. In an embodiment, the edge seal 120 comprises a protruding elastomer strip of equal or lower durometer than the rest of the outer wall 104.

FIG. 2 shows a cross-sectional view of the elastomeric bladder tool 100 to demonstrate the collapsed natural state of the elastomeric bladder tool 100, and also depicts a layered construction of the outer wall 104 of the elastomeric bladder tool 100. The outer wall 104 of the elastomeric bladder tool 100 can comprise any material capable of withstanding the selected composite curing conditions, while not interfering with the composite patch resin system used in repairing a composite structure. For example, the outer wall 104 can comprise any variation or combination of natural or synthetic rubber such as silicone, fluoroelastomers, butyl-rubber, or ethylene propylene diene monomer rubber (EPDM). An outer film 202 can be made of a fluoropolymer such as Polytetrafluoroethylene (PTFE) or Fluorinated Ethylene Propylene (FEP) or similar inert polymers in order to reduce friction during installation and extraction of the elastomeric bladder tool 100. The outer film 202 can also act as an inert barrier between the elastomeric bladder tool 100 and the composite repair patch material. Within the outer wall 104, heating elements 102 (e.g., resistance wire) is arranged across the length of the elastomeric bladder tool 100. In various embodiments, the heating elements 102 may be arranged in a particular pattern to provide even heat distribution throughout the elastomeric bladder tool 100. The pattern of the heating elements 102 may also allow the bladder to maintain its flexibility during installation and extraction. In an embodiment, a surrounding layer 204 around the heating element/resistance wire 102 can comprise woven glass to act as a protective containment barrier. As mentioned above, and described in greater detail below, the heating elements/resistance wire 102 can be connected to an external power source and/or temperature controller to control bladder surface temperatures.

FIG. 3 depicts a cross-sectional view of the elastomeric bladder tool 100 in its collapsed and expanded states, according to an embodiment of the present disclosure. In its natural, collapsed state (302), the elastomeric bladder tool 100 has a smaller cross-sectional area than in its expanded state (304). The elastomeric bladder tool 100 can be collapsed into its natural state for easier insertion and extraction of the elastomeric bladder tool 100 into or from a repair area. Once inserted into a composite structure repair area, the elastomeric bladder tool 100 can be expanded into its expanded state in order to provide support and interior heat to uncured plies laid on the composite structure repair area.

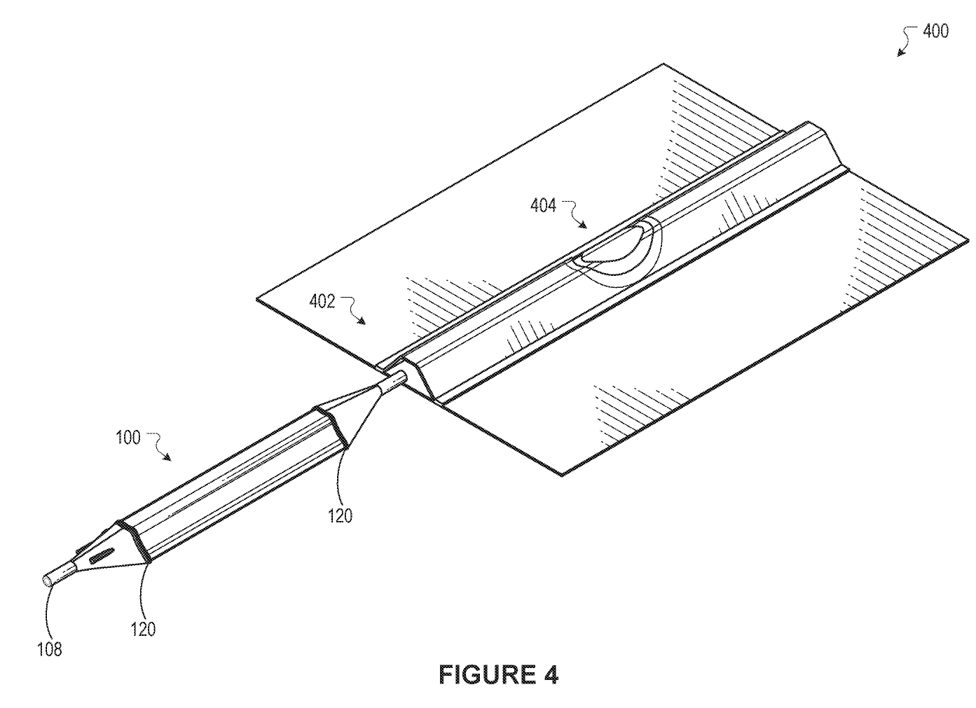

FIG. 4 illustrates an example composite structure repair scenario 400, according to an embodiment of the present disclosure. The depicted example scenario 400 includes a damaged stringer 402. A repair area 404 (or damaged area 404) can first be cut out and scarfed to allow for better bonding and to improve subsequent load transfers throughout the repair. Depending on how heavily the repair area is loaded, the taper can vary between 30 to 100 times the repair thickness. Heavily loaded areas may have a shallower taper than lightly loaded repairs.

In certain embodiments, the elastomeric bladder tool 100 can be inserted inside a cavity, such as the stringer 402, and placed directly under the repair area 404. As discussed above, the elastomeric bladder tool 100 can be in a collapsed state when inserted into the stringer 402. Positive pressure can be introduced to the elastomeric bladder tool 100 (e.g., via end fitting 108) to expand the elastomeric bladder tool into an expanded state. In the expanded state, the elastomeric bladder tool 100 can support uncured plies laid on the repair area 404 during layup. Heating elements embedded within the elastomeric bladder tool can be warmed in order to apply heat to an interior surface of the repair area 404 in order to more quickly and more effectively cure uncured plies laid on the repair area 404. Raised edge seals 120 allow the elastomeric bladder tool 100 to seal off the interior of the stringer to avoid the use of an inner vacuum bag during the curing process. After the outer vacuum bag system is in place with new uncured plies, the heating elements within the elastomeric bladder tool 100 can be activated to bring the system up to temperature.

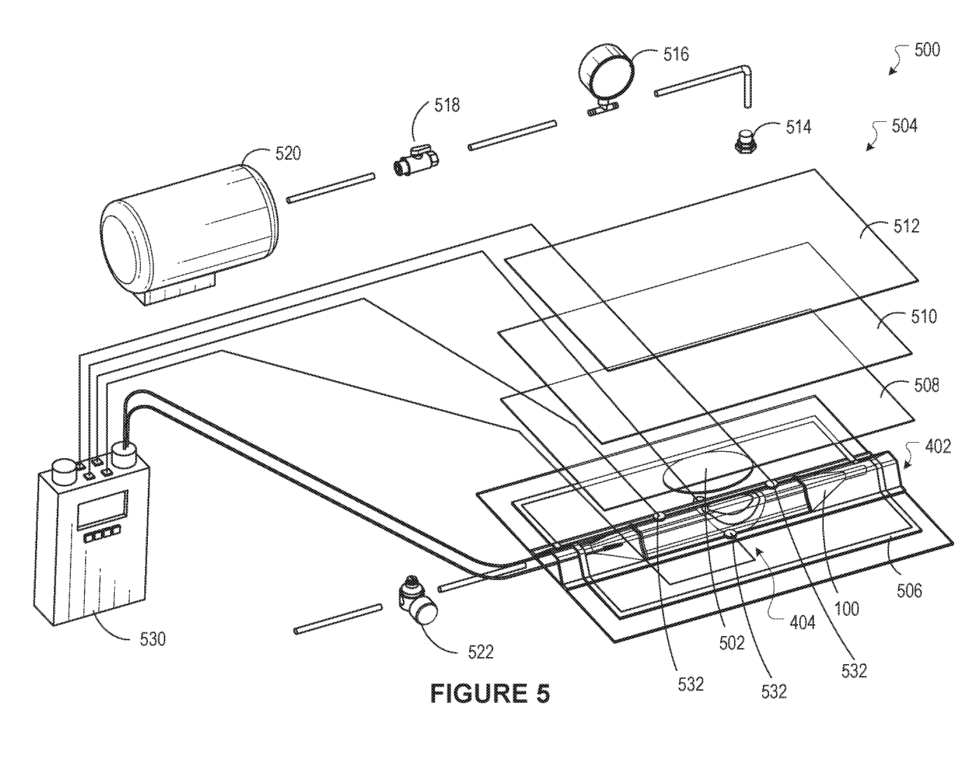

FIG. 5 illustrates a composite structure repair system 500, according to an embodiment of the present disclosure. The composite structure repair system 500 shown in FIG. 5 includes the components of the composite structure repair scenario 400 of FIG. 4. However, in FIG. 5, the elastomeric bladder tool 100 has been inserted into the stringer 402 in order to support the repair area 404. New, uncured plies 502 (also referred to as a composite repair patch) are placed over the repair area 404. The orientation of the new plies 502 may, in certain embodiments, imitate the original ply direction of the composite being repaired. A vacuum bag system 504 is placed over the repair area 404 and the new plies 502. In the depicted embodiment, the vacuum bag system 504 comprises: sealant tape 506, a release film 508, a breather cloth 510, and an exterior bag 512. As discussed above, raised edge seals on both ends of the elastomeric bladder tool 100 create an air-tight seal within the interior of the stringer 402 when the elastomeric bladder tool 100 is deployed to its expanded state, thereby eliminating the need for an interior vacuum bag.

The composite structure repair system 500 includes a vacuum connector 514 that is installed on the exterior bag 512 and connected to a vacuum gage 516. The vacuum gage 516 is connected to a two-way valve 518 and a vacuum pump 520. The vacuum pump 520 can be configured to evacuate air within the vacuum bag system 504 to ensure that the new plies 502 maintain contact with the damaged area 404 of the composite structure being repaired during the curing process. At one end, the elastomeric bladder tool 100 is connected to a pressure regulator 522 via an end fitting (e.g., end fitting 108 of FIG. 1). The pressure regulator 522 can be configured to apply and maintain positive pressure within the elastomeric bladder tool 100 during the curing process by forcing gas into the bladder tool. In certain embodiments, the pressure regulator 522 can also be configured to evacuate pressure from within the elastomeric bladder tool 100 in order to facilitate insertion and/or extraction of the elastomeric bladder tool 100. The length of the elastomeric bladder tool 100 can be varied depending on the location of the repair area 404 within the composite structure. The elastomeric bladder tool 100 can be connected to a temperature controller 530 using heating element leads on the elastomeric bladder tool 100 (e.g., leads 110 of FIG. 1). Thermocouples 532 can be placed around the repair area 404 to monitor the temperature via the temperature controller 532.

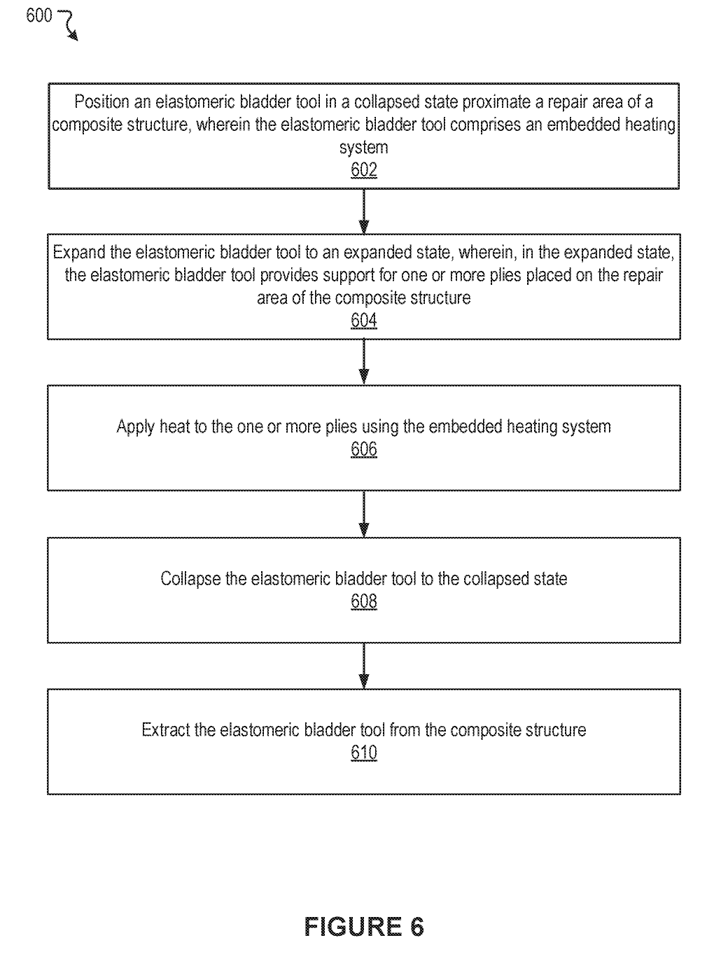

FIG. 6 depicts a flow chart of an example method 600 associated with repairing a composite structure using a collapsible, heated elastomeric bladder tool, according to an embodiment of the present disclosure. At block 602, the example method 600 can position an elastomeric bladder tool in a collapsed state proximate a repair area of a composite structure, wherein the elastomeric bladder tool comprises an embedded heating system. At block 604, the example method 600 can expand the elastomeric bladder tool to an expanded state, wherein, in the expanded state, the elastomeric bladder tool provides support for one or more plies placed on the repair area of the composite structure. At block 606, the example method 600 can apply heat to the one or more plies using the embedded heating system. At block 608, the example method 600 can collapse the elastomeric bladder tool to the collapsed state. At block 610, the example method 600 can extract the elastomeric bladder tool from the composite structure.

While various embodiments of the disclosed technology have been described above, it should be understood that they have been presented by way of example only, and not of limitation. Likewise, the various diagrams may depict an example structure or configuration for the disclosed technology, which is done to aid in understanding the features and functionality that can be included in the disclosed technology. The disclosed technology is not restricted to the illustrated example structures or configurations, but the desired features can be implemented using a variety of alternative structure and configurations. Indeed, it will be apparent to one of skill in the art how alternative functional, logical or physical partitioning and configurations can be implemented to implement the desired features of the technology disclosed herein. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular structure or configuration.

Although the disclosure has been presented with reference only to the presently preferred embodiments, those of ordinary skill in the art will appreciate that various modifications can be made without departing from this disclosure. As such, the disclosure is defined only by the following claims and recited limitations.

1. An elastomeric bladder tool comprising:
an elastomeric outer wall;
an inner cavity at least partially defined by the elastomeric outer wall; and
an embedded heating system embedded within the elastomeric outer wall.

2. The elastomeric bladder tool of claim 1, wherein the embedded heating system comprises resistance wire embedded within the elastomeric outer wall.

3. The elastomeric bladder tool of claim 2, wherein the embedded heating system distributes heat throughout the elastomeric outer wall and maintains flexibility of the elastomeric outer wall.

4. The elastomeric bladder tool of claim 2, wherein the embedded heating system further comprises woven glass surrounding the resistance wire.

5. The elastomeric bladder tool of claim 1, further comprising one or more raised edge seals positioned along and protruding from the elastomeric outer wall.

6. The elastomeric bladder tool of claim 5, wherein the one or more raised edge seals comprise elastomer material of equal or lower durometer than the elastomeric outer wall.

7. The elastomeric bladder tool of claim 1, wherein the elastomeric outer wall comprises at least one of: fluoroelastomer, silicone, butyl-rubber, or ethylene propylene diene monomer rubber (EPDM).

8. The elastomeric bladder tool of claim 1, wherein the elastomeric outer wall comprises an outermost layer, and the outermost layer comprises an inert polymer to reduce friction during insertion or extraction of the elastomeric bladder tool from a composite structure.

9. The elastomeric bladder tool of claim 1, wherein the elastomeric outer wall is in a collapsed state in normal atmospheric conditions, and the elastomeric outer wall can be expanded into an expanded state by applying positive pressure to the inner cavity.

10. The elastomeric bladder tool of claim 9, further comprising an end fitting configured to allow gas or fluid to be inserted into and extracted from the internal cavity.

11. A method comprising:
positioning an elastomeric bladder tool in a collapsed state proximate a repair area of a composite structure, wherein the elastomeric bladder tool comprises an embedded heating system;
expanding the elastomeric bladder tool to an expanded state, wherein, in the expanded state, the elastomeric bladder tool provides support for one or more plies placed on the repair area of the composite structure; and
applying heat to the one or more plies using the embedded heating system.

12. The method of claim 11, further comprising:
collapsing the elastomeric bladder tool to the collapsed state; and
extracting the elastomeric bladder tool from the composite structure in the collapsed state.

13. A method of claim 11, wherein the elastomeric bladder tool comprises one or more raised edge seals positioned along and protruding from an outer surface of the elastomeric bladder tool.

14. The method of claim 13, wherein expanding the elastomeric bladder tool to the expanded state causes the one or more raised edge seals to create an air-tight seal around the repair area.

15. A composite structure repair system comprising:
a composite structure comprising a repair area to be repaired;
one or more plies positioned on the repair area;
an elastomeric bladder tool positioned proximate the one or more plies, the elastomeric bladder tool comprising
an elastomeric outer wall,
an inner cavity at least partially defined by the elastomeric outer wall, and
an embedded heating system embedded within the elastomeric outer wall;
a pressure regulator in communication with the inner cavity for alternating the elastomeric bladder tool between a collapsed state and an expanded state; and
a temperature controller connected to the embedded heating system for controlling a temperature of the embedded heating system.

16. The composite structure repair system of claim 15, wherein, in the expanded state, the elastomeric bladder tool provides support for the one or more plies.

17. The composite structure repair system of claim 16, wherein, in the expanded state, the elastomeric bladder tool is configured to apply heat to an interior surface of the one or more plies using the embedded heating system.

18. The composite structure repair system of claim 15, wherein the elastomeric bladder tool further comprises one or more raised edge seals positioned along and protruding from the elastomeric outer wall.

19. The composite structure repair system of claim 18, wherein when the elastomeric bladder tool is expanded to the expanded state, the one or more raised edge seals create an air-tight seal around the repair area and the one or more plies.

20. The composite structure repair system of claim 19, wherein the one or more raised edge seals comprise elastomer material of equal or lower durometer than the elastomeric outer wall.
